(19) United States
(12) Patent Application Publication
(10) Pub. No.: US 2012/0064225 A1
(43) Pub. Date: Mar. 15, 2012

(54) SPRAY DEPOSITION MODULE FOR AN IN-LINE PROCESSING SYSTEM

(75) Inventors: Robert Z. Bachrach, Burlingame, CA (US); Connie P. Wang, Mountain View, CA (US); Sergey D. Lopatin, Morgan Hill, CA (US); Hooman Bolandi, San Jose, CA (US); Ruben Babayants, Mountain View, CA (US); Karl M. Brown, San Jose, CA (US); Michael C. Kutney, Santa Clara, CA (US)

(73) Assignee: APPLIED MATERIALS, INC., Santa Clara, CA (US)

(21) Appl. No.: 12/880,564

(22) Filed: Sep. 13, 2010

(51) Int. Cl. H01M 10/04; B05B 5/025; B05C 9/14; B05C 5/00

(52) U.S. Cl. 427/58; 118/313; 118/621; 118/58

(57) ABSTRACT

In one embodiment, an apparatus for simultaneously depositing an anodically or cathodically active material on opposing sides of a flexible conductive substrate is provided. The apparatus comprises a chamber body defining one or more processing regions in which a flexible conductive substrate is exposed to a dual sided spray deposition process, wherein each of the one or more processing regions are further divided into a first spray deposition region and a second spray deposition region for simultaneously spraying an anodically active or cathodically active material onto opposing sides of a portion of the flexible conductive substrate, wherein each of the first and second spray deposition regions comprise a spray dispenser cartridge for delivering the activated material toward the flexible conductive substrate and a movable collection shutter.

### BACKGROUND OF THE INVENTION

1. Field of the Invention

Embodiments of the present invention generally relate to lithium-ion batteries and battery cell components, and more specifically, to a system and an apparatus for fabricating structures which may include bi-layer battery cells and bi-layer battery cell components using spray deposition techniques.

2. Description of the Related Art

High-capacity energy storage devices, such as lithium-ion (Li-ion) batteries, are used in a growing number of applications, including portable electronics, medical, transportation, grid-connected large energy storage, renewable energy storage, and uninterruptible power supply (UPS).

For most applications of energy storage devices, the charge time and energy capacity of energy storage devices are important parameters. In addition, the size, weight, and/or expense of manufacturing such energy storage devices are significant factors.

One method for manufacturing energy storage devices is principally based on slit coating of viscous powder slurry mixtures of cathodically or anodically active material onto a conductive current collector followed by prolonged heating to form a dried cast sheet and prevent cracking. The thickness of the electrode after drying which evaporates the solvents is finally determined by compression or calendaring which adjusts the density and porosity of the final layer. Slit coating of viscous slurries is a highly developed manufacturing technology which is very dependent on the formulation, formation, and homogenation of the slurry. The formed active layer is extremely sensitive to the rate and thermal details of the drying process.

Among other problems and limitations of this technology is the slow and costly drying component which requires both a large long footprint and an elaborate collection and recycling system for the evaporated volatile components. Many of these are volatile organic compounds which additionally require an elaborate abatement system. Further, the resulting electrical conductivity of these types of electrodes also limits the thickness of the electrode and thus the volume of the electrode.

Accordingly, there is a need in the art for systems and apparatus for more cost effectively manufacturing faster charging, higher capacity energy storage devices that are smaller, lighter, and can be manufactured at a high production rate.

### SUMMARY OF THE INVENTION

Embodiments of the present invention generally relate to lithium-ion batteries and battery cell components, and more specifically, to a system and an apparatus for fabricating structures which may include bi-layer battery cells and bi-layer battery cell components using spray deposition techniques. In one embodiment, an apparatus for simultaneously depositing an anodically or cathodically active material on opposing sides of a flexible conductive substrate is provided. The flexible conductive substrate may be either horizontally or vertically oriented. The apparatus comprises a modular chamber body defining one or more processing regions in which the flexible conductive substrate is exposed to a dual sided deposition process, wherein each of the one or more processing regions are further divided into a first spray deposition region and a second spray deposition region for simultaneously spraying the active material onto opposing sides of a portion of the flexible conductive substrate, a first spray dispenser cartridge disposed in the first spray deposition region for spraying the active material toward the flexible conductive substrate, a first movable collection shutter disposed in the first spray deposition region for blocking a flow path of the active material from the first spray dispenser cartridge when in a closed position, a second spray dispenser cartridge disposed in the second spray deposition region for spraying the active material toward the flexible conductive substrate, and a second movable collection shutter disposed in the second spray deposition region for blocking a flow path of the active material from the second spray dispenser cartridge when in a closed position.

In another embodiment, a modular substrate processing system for simultaneously depositing an anodically or cathodically active material on opposing sides of a flexible conductive substrate is provided. The modular substrate processing system comprises a modular microstructure formation chamber configured to form a plurality of conductive pockets over a flexible conductive substrate, a dual sided active material spray chamber for depositing the active material over the plurality of conductive pockets, wherein the spray deposition chamber has one or more processing regions in which a flexible conductive substrate is exposed to a dual sided deposition process, wherein each of the one or more processing regions are further divided into a first spray deposition region and a second spray deposition region each for simultaneously spraying an anodically active or cathodically active material onto opposing sides of a portion of the flexible conductive substrate, a first spray dispenser cartridge disposed in the first spray deposition region for delivering the active material toward the flexible conductive substrate, a first movable collection shutter disposed in the first spray deposition region for blocking a flow path of active material from the spray dispenser cartridge and collecting the active material when in a closed position and allowing for a flow of the active material toward the flexible conductive substrate when in an open position, a second spray dispenser cartridge disposed in the second spray deposition region for delivering the active material toward the flexible conductive substrate, a second movable collection shutter disposed in the second spray deposition region for blocking a flow path of active material from the second spray dispenser cartridge and collecting the active material when in a closed position and allowing for a flow of the active material toward the flexible conductive substrate when in an open position, and a substrate transfer mechanism configured to transfer the flexible conductive substrate among the chambers.

In yet another embodiment, a method for simultaneously depositing an electro-active material on opposing sides of a flexible conductive substrate is provided. The method comprises translating a portion of the flexible conductive substrate having a three dimensional porous structure deposited thereon through a first processing region of a dual sided active material spray chamber between a first spray dispenser cartridge and a second spray dispenser cartridge, spraying a first electro-active material over the portion of the substrate having the three dimensional porous structure on opposing sides of the flexible conductive substrate using the first spray dispenser cartridge and the second spray dispenser cartridge to form a first layer, translating the portion of the flexible conductive substrate having the first electro-active material deposited thereon through a second processing region of the spray deposition chamber between a third spray dispenser cartridge and a fourth spray dispenser cartridge, and spraying a second electro-active material over the first electro-active material on opposing sides of the flexible conductive substrate using the third spray dispenser cartridge and the fourth spray dispenser cartridge, wherein the first processing chamber and the second processing chamber are isolated from each other to prevent cross-contamination.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic illustration of one embodiment of a vertical in-line processing system according to embodiments described herein;

FIG. 2 is a perspective view of one embodiment of a portion of the in-line vertical processing system of FIG. 1 having a dual sided spray chamber according to embodiments described herein;

FIG. 3 is a schematic sectional top view of a portion of the vertical in-line processing system of FIG. 1 having a dual sided spray chamber according to embodiments described herein;

FIG. 4 is a sectional perspective side view of one embodiment of the dual sided spray chamber shown in FIG. 2;

FIG. 5 is a perspective view of one embodiment of a spray dispenser cartridge according to embodiments described herein;

FIG. 6 is a perspective view of one embodiment of the orientation of a subsidiary nozzle of a spray dispenser cartridge according to embodiments described herein;

FIG. 7 is a partial schematic side view of another embodiment of an in-line processing system; and

FIG. 8 is a partial schematic side view of another embodiment of a dual sided spray chamber.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

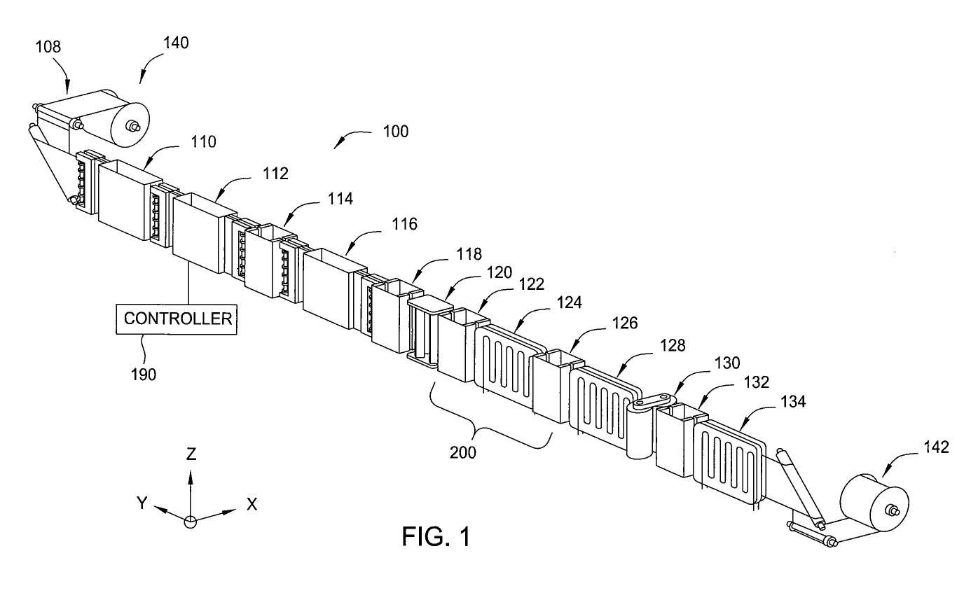

Embodiments of the present invention generally relate to lithium-ion batteries and battery cell components, and more specifically, to a system and an apparatus for fabricating structures which may include bi-layer battery cells and bi-layer battery cell components using spray deposition techniques. Spray deposition techniques include, but are not limited to, electrostatic spraying techniques, plasma spraying techniques, and thermal or flame spraying techniques. Certain embodiments described herein include the manufacturing of battery cell electrodes by incorporating electro-active powders (e.g. cathodically or anodically active materials) into three-dimensional conductive porous structures using spray deposition techniques to form anodically active or cathodically active layers on substrates which function as current collectors, for example, copper substrates for anodes and aluminum substrates for cathodes. For bi-layer battery cells and battery cell components, opposing sides of the processed substrate may be simultaneously processed to form the bi-layer structure. Exemplary embodiments of anode structures and cathode structures which may be formed using the embodiments described herein are described in FIGS. 1, 2A-2D, 3, 5A and 5B and corresponding paragraphs [0041]-[0066] and [0094]-[0100] of commonly assigned U.S. patent application Ser. No. 12/839,051, (Attorney Docket No. APPM/014080/EES/AEP/ESONG), filed Jul. 19, 2010, to Bachrach et al, titled COMPRRESSED POWDER 3D BATTERY ELECTRODE MANUFACTURING, of which the aforementioned figures and paragraphs are herein incorporated by reference.

In certain embodiments, the electro-active powders deposited may comprise nano-scale sized particles and/or micro-scale sized particles. In certain embodiments, the three-dimensional conductive porous structure is formed by at least one of: a porous electroplating process, an embossing process, or a nano-imprinting process. In certain embodiments, the three-dimensional conductive porous structure comprises a wire mesh structure. The formation of the three-dimensional conductive porous structure determines the thickness of the electrode and provides pockets or wells into which the anodically active or cathodically active powders may be deposited using the systems and apparatus described herein.

Cathodically active powders which may be deposited using the embodiments described herein include but are not limited to cathodically active particles selected from the group comprising lithium cobalt dioxide (LiCoO₂), lithium manganese dioxide (LiMnO₂), titanium disulfide (TiS₂), LiNixCO₁₋₂ₓMnO₂, LiMn₂O₄, iron olivine (LiFePO₄) and it is variants (such as LiFe₁₋ₓMgPO₄), LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, other qualified powders, composites thereof and combinations thereof.

Anodically active powders which may be deposited using the embodiments described herein include but are not limited to anodically active particles selected from the group comprising graphite, graphene hard carbon, carbon black, carbon coated silicon, tin particles, copper-tin particles, tin oxide, silicon carbide, silicon (amorphous or crystalline), silicon alloys, doped silicon, lithium titanate, any other appropriately electro-active powder, composites thereof and combinations thereof.

The use of various types of substrates on which the materials described herein are formed is also contemplated. While the particular substrate on which certain embodiments described herein may be practiced is not limited, it is particularly beneficial to practice the embodiments on flexible conductive substrates, including for example, web-based substrates, panels and discrete sheets. The substrate may also be in the form of a foil, a film, or a thin plate. In certain embodiments where the substrate is a vertically oriented substrate, the vertically oriented substrate may be angled relative to a vertical plane. For example, in certain embodiments, the substrate may be slanted from between about 1 degree to about 20 degrees from the vertical plane. In certain embodiments where the substrate is a horizontally oriented substrate, the horizontally oriented substrate may be angled relative to a horizontal plane. For example, in certain embodiments, the substrate may be slanted from between about 1 degree to about 20 degrees from the horizontal plane. As used herein, the term “vertical” is defined as a major surface or deposition surface of the flexible conductive substrate being perpendicular relative to the horizon. As used herein, the term “horizontal” is defined as a major surface or deposition surface of the flexible conductive substrate being parallel relative to the horizon.

FIG. 1 schematically illustrates one embodiment of an in-line vertical processing system 100 comprising a dual sided active material spray chamber 124 according to embodiments described herein. In certain embodiments, the processing system 100 comprises a plurality of processing chambers 110-134 arranged in a line, each configured to perform one processing step to a flexible conductive substrate 108. In one embodiment, the processing chambers 110-134 are stand alone modular processing chambers wherein each modular processing chamber is structurally separated from the other modular processing chambers. Therefore, each of the stand alone modular processing chambers, can be arranged, rearranged, replaced, or maintained independently without affecting each other. In certain embodiments, the processing chambers 110-134 are configured to process both sides of the flexible conductive substrate 108. In certain embodiments, the processing chambers 110-134 share a common transport architecture. In certain embodiments, the common transport architecture comprises a roll-to-roll system with a common take-up-roll and feed roll for the system. In certain embodiments, the common transport architecture further comprises one or more intermediate transfer rollers positioned between the take-up roll and the feed roll. In certain embodiments, the common transport architecture is a roll-to-roll system where each chamber has an individual take-up-roll and feed roll and one or more optional intermediate transfer rollers positioned between the take-up roll and the feed roll. In certain embodiments, the common transport architecture comprises a track system which extends through the processing chambers and is configured to transport either a web substrate or discrete substrates.

In one embodiment, the processing system 100 comprises a first conditioning module 110 configured to perform a first conditioning process on at least a portion of the flexible conductive substrate 108 prior to entering a microstructure formation chamber 112 for formation of a porous structure over the flexible conductive substrate 108. In certain embodiments, the first conditioning module 110 is configured to perform at least one of: heating the flexible conductive substrate 108 to increase the plastic flow of the flexible conductive substrate 108, cleaning the flexible conductive substrate 108, and pre-wetting or rinsing a portion of the flexible conductive substrate 108.

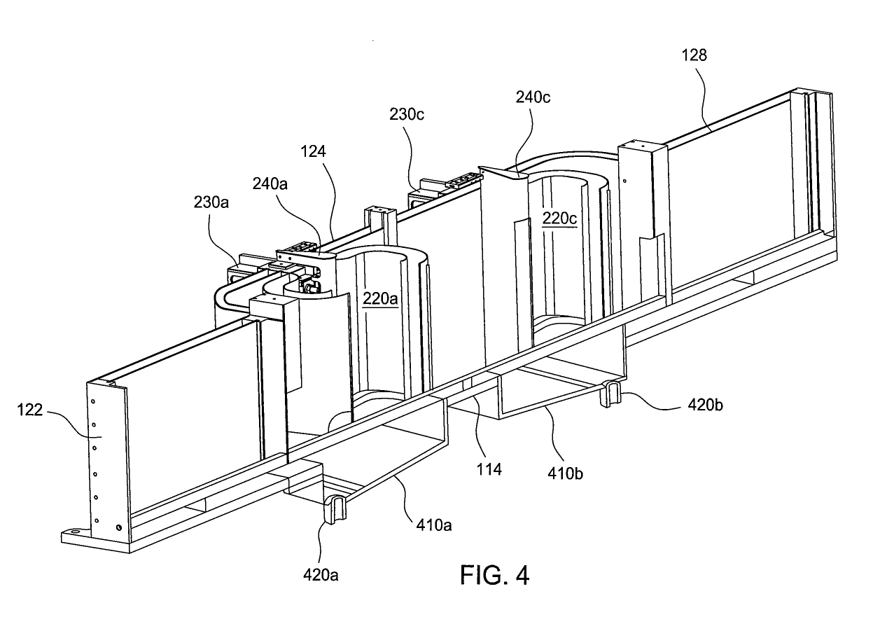

In certain embodiments, where the microstructure formation chamber 112 is an embossing chamber the chamber may be configured to emboss both sides of the flexible conductive substrate 108. One exemplary embodiment of an embossing chamber which may be used with the embodiments described herein is described in FIG. 4B and corresponding paragraphs [0087]-[0090] of commonly assigned U.S. patent application Ser. No. 12/839,051, (Attorney Docket No. APPM/014080/EES/AEP/ESONG), filed Jul. 19, 2010, to Bachrach et al, titled COMPRESSED POWDER 3D BATTERY ELECTRODE MANUFACTURING, of which FIG. 4B and corresponding paragraphs [0087]-[0090] are herein incorporated by reference. In certain embodiments, the microstructure formation chamber 112 is a plating chamber configured to perform a first plating process, for example, a copper plating process, on at least a portion of the flexible conductive substrate 108 to form pockets or wells in the flexible conductive substrate 108.

In certain embodiments, the processing system 100 further comprises a second conditioning chamber 114 which may be positioned adjacent to the microstructure formation chamber 112. In certain embodiments, the second conditioning chamber 114 is configured to perform an oxide removal process, for example, in embodiments where the flexible conductive substrate 108 comprises aluminum, the second conditioning chamber may be configured to perform an aluminum oxide removal process. In certain embodiments, where the microstructure formation chamber 112 is configured to perform a plating process, the second conditioning chamber 114 may be configured to rinse and remove any residual plating solution from the portion of the flexible conductive substrate 108 with a rinsing fluid, for example, de-ionized water, after the first plating process.

In one embodiment, the processing system 100 further comprises a second microstructure formation chamber 116 which may be positioned next to the second conditioning chamber 114. In one embodiment, the second microstructure formation chamber 116 is configured to perform a plating process, for example, tin plating, to deposit a second conductive material over the flexible conductive substrate 108. In one embodiment, the second microstructure formation chamber 116 is adapted to deposit a nano-structure over the flexible conductive substrate 108.

In one embodiment, the processing system 100 further comprises a rinse chamber 118. In one embodiment the rinse chamber 118 is configured to rinse and remove any residual plating solution from the portion of the flexible conductive substrate 108 with a rinsing fluid, for example, de-ionized water, after the plating process. In one embodiment, a chamber 120 comprising an air-knife is positioned adjacent to the rinse chamber 118.

In one embodiment, the processing system 100 further comprises a pre-heating chamber 122. In one embodiment, the pre-heating chamber 122 is configured to expose the flexible conductive substrate 108 to a drying process to remove excess moisture from the deposited porous structure. In one embodiment, the pre-heating chamber 122 contains a source configured to perform a drying process such as an air drying process, an infrared drying process, an electromagnetic drying process, or a marangoni drying process.

In one embodiment, the processing system 100 further comprises a first dual sided spray coating chamber configured to simultaneously deposit an anodically or cathodically active powder, over and/or into the conductive microstructure formed on opposing sides of the flexible conductive substrate 108. In one embodiment, the first dual sided active material spray chamber 124 is a spray coating chamber configured to deposit powder over the conductive microstructures formed over the flexible conductive substrate 108.

In one embodiment, the processing system 100 further comprises a post-drying chamber 126 which may be disposed adjacent to the first dual sided active material spray chamber 124 configured to expose the flexible conductive substrate 108 to a drying process. In one embodiment, the post-drying chamber 126 is configured to perform a drying process such as an air drying process, an infrared drying process, an electromagnetic drying process, or a marangoni drying process.

In one embodiment, the processing system 100 further comprises a second dual sided active material spray chamber 128 which may be positioned adjacent to the post-drying chamber 126. In one embodiment, the second dual sided active material spray chamber 128 is a dual sided spray coating chamber. In one embodiment, the second dual sided active material spray chamber 128 is configured to deposit an additive material such as a binder over the flexible conductive substrate 108. In certain embodiments where a two pass spray coating process is used, the first dual sided active material spray chamber 124 may be configured to deposit powder over the flexible conductive substrate 108 during a first pass using, for example, an electrostatic spraying process, and the second dual sided active material spray chamber 128 may also be configured for an electrostatic spraying process to deposit powder over the conductive substrate 108 in a second pass.

In one embodiment, the processing system 100 further comprises a compression chamber 130 which may be positioned adjacent to the post-drying chamber 126 configured to expose the flexible conductive substrate 108 to a compression process. In one embodiment, the compression chamber 130 is configured to compress the as-deposited powder into the conductive microstructure. In one embodiment, the compression chamber 130 is configured to compress the powder via a calendaring process.

In one embodiment, the processing system 100 further comprises an additional drying chamber 132 which may be positioned adjacent to the compression chamber 130 and configured to expose the flexible conductive substrate 108 to a drying process. In one embodiment, the additional drying chamber 132 is configured to perform a drying process such as an air drying process, an infrared drying process, an electromagnetic drying process, or a marangoni drying process.

In one embodiment, the processing system 100 further comprises a third active material deposition chamber 134 which may be positioned adjacent to the additional drying chamber 132. Although discussed as a spray coating chamber, the third active material deposition chamber 134 may be configured to perform any of the aforementioned powder deposition processes. In one embodiment, the third active material deposition chamber may be configured to perform an electrospinning process. In one embodiment, the third active material deposition chamber 134 is configured to deposit a separator layer over the flexible conductive substrate.

The processing chambers 110-134 are generally arranged along a line so that portions of the flexible conductive substrate 108 can be streamlined through each chamber through a common transport architecture including feed roll 140 and take up roll 142. In one embodiment, each of the processing chambers 110-134 has separate feed rolls and take-up rolls with one or more optional intermediate transfer rollers. In certain embodiments, the common transport architecture comprises a linear track system for transporting discrete substrates through the vertical processing system. In one embodiment, the feed rolls and take-up rolls may be activated simultaneously during substrate transferring in conjunction with the one or more optional intermediate transfer rollers to move each portion of the flexible conductive substrate 108 one chamber forward.

In certain embodiments, the vertical processing system 100 further comprises additional processing chambers. The additional processing chambers may comprise one or more processing chambers selected from the group of processing chambers comprising an electrochemical plating chamber, an electroless deposition chamber, a chemical vapor deposition chamber, a plasma enhanced chemical vapor deposition chamber, an atomic layer deposition chamber, a rinse chamber, an anneal chamber, a drying chamber, a spray coating chamber, and combinations thereof. It should also be understood that additional chambers or fewer chambers may be included in the in-line processing system. Further, it should be understood that the process flow depicted in FIG. 1 is only exemplary and that the processing chambers may be rearranged to perform other process flows which occur in different sequences.

A controller 190 may be coupled with the vertical processing system 100 to control operation of the processing chambers 110-134, the feed roll 140 and the take up roll 142. The controller 190 may include one or more microprocessors, microcomputers, microcontrollers, dedicated hardware or logic, and a combination of the same.

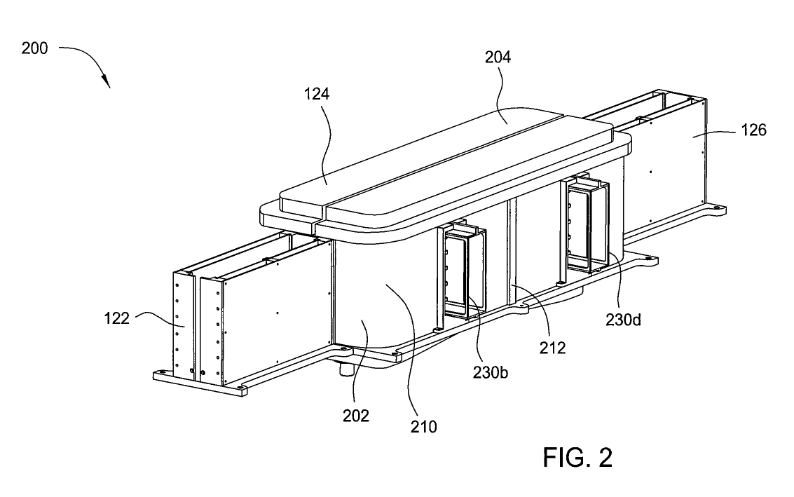

FIG. 2 is a schematic sectional top view of a portion 200 of the in-line vertical processing system 100 of FIG. 1 having a first dual sided active material spray deposition chamber 124 according to embodiments described herein. The portion 200 of the vertical processing system 100 comprises the pre-heating chamber 122, the first dual sided active material spray chamber 124, and the post-dry chamber 126. The first dual sided active material spray chamber 124 comprises a modular chamber body 202 which may be mounted or otherwise connected with other processing chambers of the vertical processing system 100. The first dual sided active material spray chamber 124 may share a common transport architecture with the other chambers of the vertical processing system 100. The modular chamber body 202 defines one or more isolated processing regions in which a flexible conductive substrate, such as flexible conductive substrate 108 may be exposed to a dual sided spray deposition process. The modular chamber body 202 may support a lid 204 which may be hingedly attached to the chamber body 202. The chamber body 202 includes a sidewall 210, an interior wall 212 which divides the processing region into two separate processing regions, and a bottom wall 214.

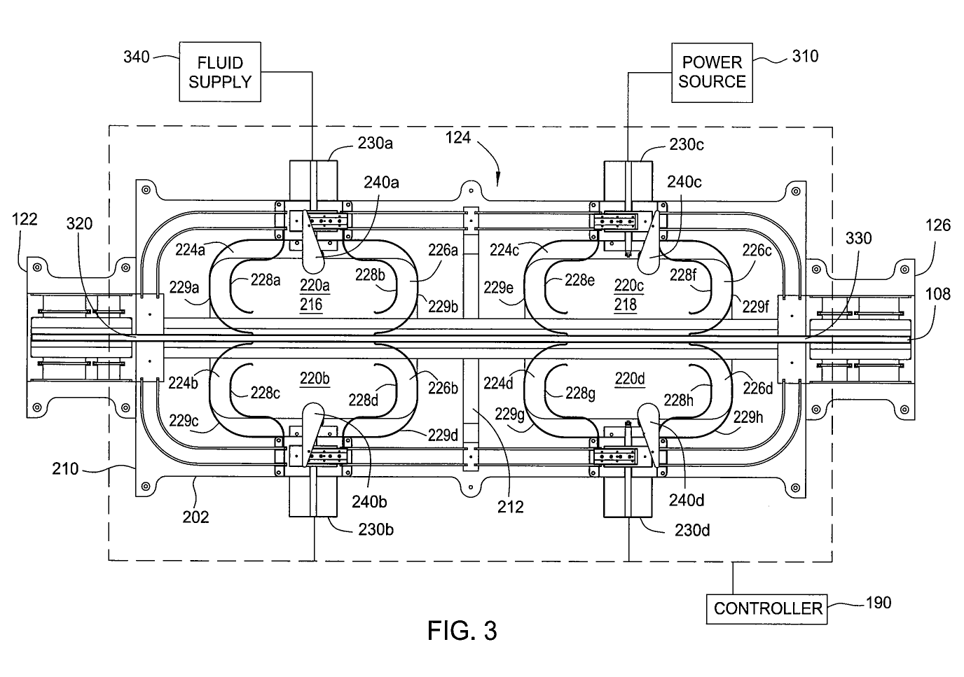

FIG. 3 is a schematic sectional top view of a portion of one embodiment of a portion 200 of the vertical processing system 100 of FIG. 1 having the first dual sided active material spray chamber 124 according to embodiments described herein. The sidewall 210, interior wall 212 and bottom wall 214 (see FIG. 3) define two separate processing regions 216, 218. The sidewall 210 and the interior wall 212 define two rectangular processing regions 216, 218. The interior wall 212 is positioned between the two processing regions 216, 218 to isolate the two processing regions 216, 218 from each other to prevent cross-contamination.

Each processing region 216, 218 is further divided into two opposing spray deposition regions for simultaneously processing opposing sides of a substrate. The first processing region 216 is divided into a first spray deposition region 220a and a second spray deposition region 220b and the second processing region 218 is also divided into a first spray deposition region 220c and a second spray deposition region 220d. Each spray deposition region 220a-d is defined by a first semicircular pumping channel 224a-d and a second opposing semicircular pumping channel 226a-d each of which may extend the height of sidewall 210 for exhausting gases from each spray deposition region 220a-d and controlling the pressure within each spray deposition region 200a-220d. Each semicircular pumping channel 224a-d and 226a-d is defined by an interior wall 228a-h and an exterior wall 229a-h.

Each spray deposition region 220a-d comprises a spray dispenser cartridge 230a-d for delivering an activated precursor toward the flexible conductive substrate 108 and a movable collection shutter 240a-d for blocking the path of and collecting the activated precursor when in a closed position and allowing for the flow of the activated precursor toward the flexible conductive substrate 108 when in an open position.

The movable collection shutter 240a-d may be dimensioned to extend the length of the spray dispenser cartridge 230a-d such that the movable collection shutter 240a-d will block the flow of activated precursor or other spray from any dispensing nozzles of the spray dispenser cartridge 230a-d.

The spray dispenser cartridge 230a-d may be removably inserted into the sidewall 210 of the chamber body 202 allowing for easy removal and replacement of spent or damaged cartridges with minimal interruption of the process flow.

The spray dispenser cartridge 230a-d may be coupled with a power source 310 for exposing the deposition precursor to an electric field to energize the deposition precursor. The power source 310 may be an RF or DC source. Electrical insulators may be disposed in the chamber sidewalls 210 and/or in the spray dispenser cartridge 230a-d to confine the electric field to the spray dispenser cartridge 230a-d.

The spray dispenser cartridges 320a-d may also be coupled with a fluid supply 340 for supplying precursors, processing gases, processing materials such as cathodically active particles, anodically active particles, propellants, and cleaning fluids.

FIG. 4 is a sectional perspective side view of one embodiment of the first dual sided active material spray chamber 124 shown in FIG. 2. As shown in FIG. 4, the bottom wall 214 of the first dual sided active material spray chamber 124 may open to form catch basins 410a, 410b for capturing overflow precursors and other overflow fluids. Each catch basin 410a and 410b may have a corresponding drain 420a, 420b. In certain embodiments, each spray deposition region 220a-d has a separate catch basin positioned beneath each spray deposition region 220a-d. In certain embodiments the movable collection shutters 240a-d when in a closed position direct overflow precursor into each catch basin 410a, 410b.

In one embodiment, the spray dispenser cartridges 230a-d each comprise multiple dispensing nozzles oriented and positioned across the path of the flexible conductive substrate 408 to cover the substrate uniformly as it travels between the spray dispenser cartridges 230a, 230b and 230c, 230d. In certain embodiments, each powder dispenser cartridge has multiple nozzles, similar to cartridges 230a-d, and may be configured with all nozzles in a linear configuration, or in any other convenient configuration. To achieve full coverage of the flexible conductive substrate, each dispenser may be translated across the flexible conductive substrate 408 while spraying activated precursor, or the flexible conductive substrate 408 may be translated between the spray dispenser cartridge 230a, 230b and 230c, 230d, or both.

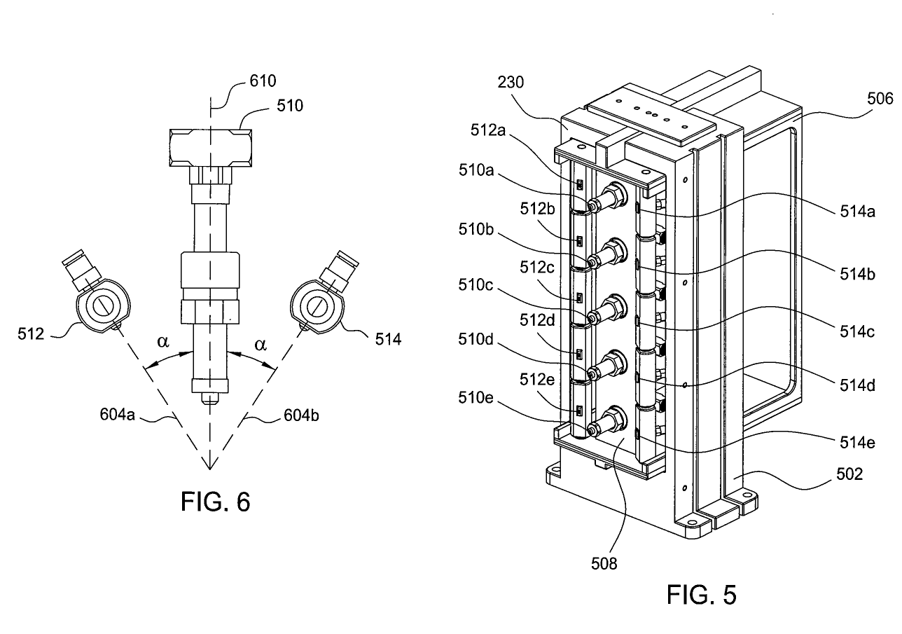

FIG. 5 is a perspective view of one exemplary embodiment of a spray dispenser cartridge 230 according to embodiments described herein. The spray dispenser cartridge 230 comprises a dispenser body 502 coupled with a handle 506 for ease of placement and removal of the spray dispenser cartridge 230 from the chamber body 202 and a face plate 508 for positioning and securing one or more spray nozzles 510a-e to the dispenser body 502. As shown in FIG. 5, a plurality of spray nozzles 510a-e are coupled with the face plate 508 each spray nozzle 510a-e having a corresponding pair of subsidiary nozzles 512a-e, 514a-e positioned on opposing sides of each spray nozzle 510a-e for delivering air toward the precursor stream exiting each spray nozzle 510a-e.

FIG. 6 is a perspective view of one embodiment of the orientation of a subsidiary nozzle of a spray dispenser cartridge according to embodiments described herein. A central axis 604a, 604b of each of the subsidiary nozzles 512a-e, 514a-e may be angled at an angle a relative to a central axis 610 which longitudinally transverses a center of each spray nozzle 510a-e. In one embodiment, each of the subsidiary nozzles 512a-e, 514a-e may be independently angled at between five degrees and fifty degrees relative to the central axis. In another embodiment, each of the subsidiary nozzles 512a-e, 514a-e may be independently angled at between twenty degrees and thirty degrees relative to the central axis. In certain embodiments where the precursor stream exits the spray nozzle 510a-e as a liquid, the subsidiary nozzle 512a-e, 514a-e delivers heated air to the liquid precursor stream allowing for in-flight evaporation of the liquid precursor stream to separate a portion of the liquid from the activated material prior to reaching the surface of the flexible conductive substrate 108.

The dispenser body 502 is dimensioned such that the spray dispenser may be movably secured to the chamber body 202. The spray dispenser body 502 may be movable in at least one of the x-direction and the y-direction to allow for varying coverage of the surface of the flexible conductive substrate 108. The spray dispenser cartridge 230a-d may be adjusted to increase or decrease the distance between each nozzle 510a-e relative to the flexible conductive substrate 108. The ability to adjust the spray dispenser cartridge 230a-d relative to the flexible conductive substrate 108 provides control over the size of the spray pattern. For example, as the distance between the flexible conductive substrate 108 and the spray nozzles 510a-e increases the spray pattern opens up to cover a larger surface area of the flexible conductive substrate 108, however, as the distance increases, the velocity of the spray decreases. In one embodiment, the distance between the flexible conductive substrate 108 and a tip of the spray nozzle 510a-e is between five and twenty centimeters. It should also be understood that FIG. 5 depicts one exemplary embodiment and the spray dispenser cartridge 230a-d may comprise any number of spray nozzles 510 and/or subsidiary nozzles 512, 514 sufficient to uniformly cover a desired area of the flexible conductive substrate 108. In certain embodiments, the spray nozzles 510a-e may be coupled with an actuator allowing movement of the spray nozzles relative to the spray dispenser. In certain embodiments each spray nozzle 510a-e has its own flow and pressure control. In certain embodiments, each subsidiary nozzle 512, 514 has its own flow and pressure control.

In one embodiment, the spray dispenser cartridge 230a-d moves with respect to the flexible conductive substrate 108 in order to deposit activated particles over all, or a substantial portion of the flexible conductive substrate 108. This may be accomplished by moving at least one of the spray dispenser cartridge 230a-d, the one or more spray nozzles of each spray dispenser cartridge 230a-d, and the flexible conductive substrate 108. In one embodiment, the spray dispenser cartridge 230a-d may be configured to move across the spray deposition region using an actuator. Alternately, or in addition, the feed roll 140 and the take-up roll 142 and any optional intermediate transfer rollers may have a positioning mechanism allowing the substrate to move in the z-direction to allow for uniform coverage of the flexible conductive substrate 108.

Each of the one or more nozzles may be coupled with a mixing chamber (not shown), which may feature an atomizer for liquid, slurry or suspension precursor, where the deposition precursor is mixed with the gas mixture prior to delivery into the spray deposition region.

In certain embodiments, each spray nozzle 510a-e may be coupled with a cleaning liquid source, for example, a deionized water source, and a non-reactive gas source, for example a nitrogen gas source for cleaning and eliminating clogging of each spray nozzle 510a-e to prevent each spray nozzle 510a-e from drying out.

In certain embodiments, a gas mixture that exits the spray dispenser cartridge 230a-d comprises the activated particles to be deposited on the substrate carried in a carrier gas mixture and may optionally comprise combustion products. The gas mixture may contain at least one of water vapor, carbon monoxide and dioxide, and trace quantities of vaporized electrochemical materials, such as metals. In one embodiment, the gas mixture comprises a non-reactive carrier gas component, such as argon (Ar) or nitrogen (N₂) that is used to help deliver the activated material to the substrate.

The gas mixture comprising the activated particles may further comprise a combustible mixture for triggering a combustion reaction which releases thermal energy and causes the activated material to propagate toward the flexible conductive substrate 108 in spray patterns. The spray patterns may be shaped by at least one of the nozzle geometry, speed of gas flow, and speed of the combustion reaction to uniformly cover substantial portions of the flexible conductive substrate 108. In certain embodiments, where the spray dispenser cartridge 230a-d comprises multiple spray nozzles, the nozzles may be disposed in a linear configuration, or any other convenient configuration which allows for uniform coverage of the surface of the flexible conductive substrate 108 as it travels between the opposing multi-head spray cartridges.

Pressure and gas flows are adjusted within the active material spray chamber 124 such that when the gas mixture comprising the activated particles and the carrier gas mixture contacts the flexible conductive substrate 108, the activated particles remain on the flexible conductive substrate 108 while the gas is reflected off of the flexible conductive substrate 108. In order to prevent the reflected gas from flowing backwards into the path of the gas mixture exiting the spray nozzles 510a-e an exhaust path is established using the semicircular pumping channels 224a-d, 226a-d. The exhaust flow path removes the reflected gas from each spray deposition region 220a-d by exhausting the reflected gas from the spray deposition region 220a-d via the semicircular pumping channels 224a-d, 226a-d. The semicircular pumping channels 224a-d, 226a-d. may be coupled with an exhaust portal (not shown) which may have any convenient configuration. The exhaust portal may be a single opening in the wall of the chamber body 202 or multiple such openings or a semicircular exhaust channel disposed around the circumference of the chamber body 202.

In one exemplary embodiment, a portion of a flexible conductive substrate, such as substrate 108, having a three dimensional porous structure deposited thereon, enters the active material spray chamber 124 through a first opening 320 in the sidewall 210 and travels through the first processing region 216 between the spray dispenser cartridges 230a, 230b, which deposit a first powder over the three dimensional porous structure on opposing sides of the flexible conductive substrate 108 to form a first layer. The portion of the substrate then translated through the second processing region 218, using feed roll 140 and take-up roll 142 and any optional intermediate transfer rollers, between the spray dispenser cartridges 230c, 230d where a second powder is deposited over the first powder. The portion of the substrate having been covered with the first and second powders then exits the active material spray chamber 124 through a second opening 330 for further processing. Exemplary embodiments of processes that may be performed and structures that may be formed using the apparatus described herein are described in commonly assigned U.S. Provisional Patent Application Ser. No. 61/294,628, filed Jan. 13, 2010, to Wang et al., titled GRADED ELECTRODE TECHNOLOGIES FOR HIGH ENERGY LI ION BATTERIES, all of which is hereby incorporated by reference in its entirety.

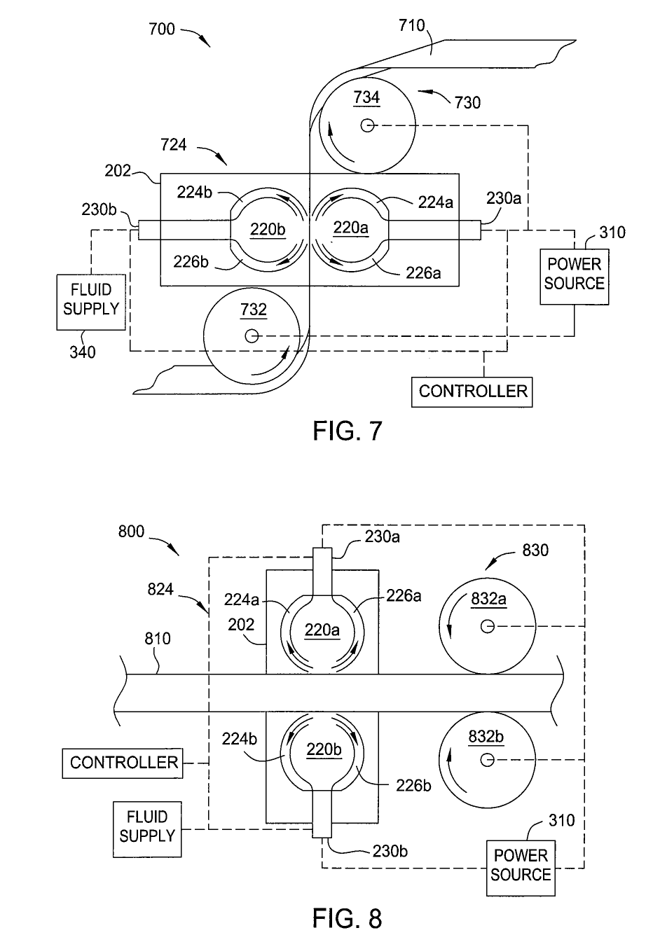

FIG. 7 is a partial schematic side view of another embodiment of an in-line processing system 700. A partial section of the in-line processing system 700 comprising a dual sided active material spray chamber 724, similar to dual sided active material spray chamber 124, and a flexible substrate transfer assembly 730 configured to move the flexible substrate base and position a portion of the flexible substrate in a spray deposition region 220a, 220b of the dual sided active material spray chamber 724. The dual sided active material spray chamber 724 is similar to the dual sided active material spray chamber 124 except that the flexible conductive substrate 710 may be re-oriented from a horizontal position to a vertical position for processing in the dual sided active material spray chamber 724 and then may be re-oriented back to a horizontal position after processing in the dual sided active material spray chamber 724.

The substrate transfer assembly 730 comprises a feed roll 732 positioned below the dual sided active material spray chamber 724 and a take-up roll 734 disposed above the dual-sided active material spray chamber 724. Each of the feed roll 732 and the take-up roll 734 is configured to retain a portion of the flexible conductive substrate 710. The flexible substrate transfer assembly 730 is configured to feed and position portions of the flexible conductive substrate 710 within the dual-sided active material spray chamber 724 during processing.

In one embodiment, at least one of the feed roll 732 and the take-up roll 734 are coupled to actuators. The feed actuator and take-up actuator are used to position and apply a desired tension to the flexible conductive substrate so that the spray processes can be performed thereon. The feed actuator and the take-up actuator may be DC servo motor, stepper motor, mechanical spring and brake, or other device that can be used to position and hold the flexible conductive substrate 710 in a desired position within the dual sided active material spray chamber 724. In one embodiment, at least one of the feed roll 732 and the take-up roll 734 are heated.

The dual sided active material spray chamber 724 is similar to the dual sided active material spray chamber 124 except that the active material spray chamber 724 contains a single processing region having a first spray deposition region 220a and a second spray deposition region 220b whereas the dual sided active material spray chamber 124 has four spray deposition regions 220a, 220b, 220c, and 220d. It should be understood that the system 700 may contain additional processing regions with multiple spray deposition regions.

FIG. 8 is a partial schematic side view of another embodiment of an in-line processing system 800. A partial section of the in-line processing system 800 comprising a dual sided spray chamber 824, similar to dual sided active material spray chamber 724 and dual sided active material spray chamber 124, and a flexible substrate transfer assembly 830 configured to move the flexible conductive substrate 810 and position a portion of the flexible substrate in the spray deposition region 220a, 220b of the dual sided spray chamber 824. The dual sided active material spray chamber 824 is similar to the dual sided spray chamber 124 and the dual sided active material spray chamber 724 except that the flexible conductive substrate 810 is in a horizontal position for processing in the dual sided spray chamber 824.

The flexible substrate transfer assembly 830 comprises transfer rolls 832a, 832b. Each of the transfer rolls 832a, 832b is configured to retain a portion of the flexible conductive substrate 810. The flexible substrate assembly 830 is configured to feed and position portions of the flexible conductive substrate 810 within the dual-sided spray chamber 824 during processing. In one embodiment, at least one of the transfer rolls 832a, 832b are heated.

While the foregoing is directed to embodiments of the present invention, other and further embodiments of the invention may be devised without departing from the basic scope thereof, and the scope thereof is determined by the claims that follow.

1. An apparatus for simultaneously depositing an anodically or cathodically active material on opposing sides of a flexible conductive substrate, comprising:
a modular chamber body defining one or more processing regions in which the flexible conductive substrate is exposed to a dual sided deposition process, wherein each of the one or more processing regions are further divided into a first spray deposition region and a second spray deposition region for simultaneously spraying the active material onto opposing sides of a portion of the flexible conductive substrate;
a first spray dispenser cartridge disposed in the first spray deposition region for spraying the active material toward the flexible conductive substrate;
a first movable collection shutter disposed in the first spray deposition region for blocking a flow path of the active material from the first spray dispenser cartridge when in a closed position;
a second spray dispenser cartridge disposed in the second spray deposition region for spraying the active material toward the flexible conductive substrate; and
a second movable collection shutter disposed in the second spray deposition region for blocking a flow path of the active material from the second spray dispenser cartridge when in a closed position.

2. The apparatus of claim 1, wherein each of the first and second spray deposition regions are defined by a first semicircular pumping channel and a second semicircular pumping channel for exhausting gases from each spray deposition region and controlling the pressure within each spray deposition region.

3. The apparatus of claim 1, wherein each of the first and second spray dispenser cartridge is removably inserted into a sidewall of the chamber body.

4. The apparatus of claim 1, wherein each spray dispenser cartridge is coupled with an electric source for exposing a deposition precursor to an electric field to energize a deposition precursor to form the active material.

5. The apparatus of claim 4, wherein the electric source is an RF source or a DC source.

6. The apparatus of claim 1, wherein the modular chamber body further comprises an interior wall dividing the one or more processing regions into two isolated processing regions to prevent cross-contamination, each isolated processing region comprising a first spray deposition region and a second spray deposition opposing the first spray deposition region for simultaneously processing opposing sides of the flexible conductive substrate.

7. The apparatus of claim 1, each spray dispenser cartridge comprises:
a dispenser body;
a face plate coupled with the dispenser body for positioning one or more spray nozzles relative to the dispenser body; and
one or more spray nozzles for delivering activated material toward the flexible conductive substrate.

8. The apparatus of claim 7, each spray dispenser cartridge further comprises:
a pair of subsidiary spray nozzles positioned on opposing sides of each of the one or more spray nozzles for delivering heated air toward the activated material allowing for in-flight evaporation of liquid from the activated material.

9. The apparatus of claim 8, wherein each of the subsidiary nozzles is independently angled at between twenty degrees and fifty degrees relative to a central axis which longitudinally traverses a center of each spray nozzle.

10. The apparatus of claim 7, wherein the spray dispenser is movable to either increase or decrease the distance between each spray nozzle relative to the flexible conductive substrate.

11. The apparatus of claim 1, further comprising an active material source coupled with each spray dispenser cartridge, wherein the active material source is a cathodically active material source selected from at least one of: lithium cobalt dioxide (LiCoO₂), lithium manganese dioxide (LiMnO₂), titanium disulfide (TiS₂), LiNixCO₁₋₂ₓMnO₂, LiMn₂O₄, iron olivine (LiFePO₄), LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, and combinations thereof.

12. A modular substrate processing system for simultaneously depositing an anodically or cathodically active material on opposing sides of a flexible conductive substrate, comprising:
a modular microstructure formation chamber configured to form a plurality of conductive pockets over a flexible conductive substrate;
a dual sided active material spray chamber for depositing the active material over the plurality of conductive pockets, wherein the spray chamber has one or more processing regions in which the flexible conductive substrate is exposed to a dual sided deposition process, wherein each of the one or more processing regions are further divided into a first spray deposition region and a second spray deposition region each for simultaneously spraying the active material onto opposing sides of a portion of the flexible conductive substrate;
a first spray dispenser cartridge disposed in the first spray deposition region for spraying the active material toward the flexible conductive substrate;
a first movable collection shutter disposed in the first spray deposition region for blocking a flow path of the active material from the spray dispenser cartridge when in a closed position;
a second spray dispenser cartridge disposed in the second spray deposition region for spraying the active material toward the flexible conductive substrate;
a second movable collection shutter disposed in the second spray deposition region for blocking a flow path of the active material from the second spray dispenser cartridge when in a closed position; and
a substrate transfer mechanism configured to transfer the flexible conductive substrate among the chambers.

13. The modular substrate processing system of claim 12, wherein the substrate transfer mechanism comprises:
a feed roll configured to retain a portion of the flexible conductive substrate; and
a take up roll configured to retain a portion of the flexible conductive substrate, wherein the substrate transfer mechanism is configured to activate the feed rolls and the take up rolls to transfer the flexible conductive substrate in and out of each chamber, and hold the flexible conductive substrate in a processing volume of each chamber for processing.

14. The modular substrate processing system of claim 12, further comprising:
a pre-heating chamber positioned between the microstructure formation chamber and the spray chamber containing a drying source selected from the group of an air drying source, an infrared drying source, an electromagnetic drying source, or a marangoni drying source configured to remove moisture from opposing sides of the flexible conductive substrate.

15. The modular substrate processing system of claim 14, further comprising:
a modular post-drying chamber positioned after the spray chamber containing a drying source selected from the group of an air drying source, an infrared drying source, an electromagnetic drying source, or a marangoni drying source configured to remove moisture from the active material deposited on opposing sides of the flexible conductive substrate.

16. The modular substrate processing system claim 12, wherein each spray dispenser cartridge comprises:
a dispenser body; and
one or more spray nozzles coupled with the dispenser body for delivering activated material toward the flexible conductive substrate.

17. The modular substrate processing system claim 16, each spray dispenser cartridge further comprises:
a pair of subsidiary spray nozzles positioned on opposing sides of each of the one or more spray nozzles for delivering heated air toward the activated material allowing for in-flight evaporation of liquid from the activated material.

18. A method for simultaneously depositing an electro-active material on opposing sides of a flexible conductive substrate, comprising:
translating a portion of the flexible conductive substrate having a three dimensional porous structure deposited thereon through a first processing region of a dual sided active material spray chamber between a first spray dispenser cartridge and a second spray dispenser cartridge;
spraying a first electro-active material over the portion of the flexible conductive substrate having the three dimensional porous structure on opposing sides of the flexible conductive substrate using the first spray dispenser cartridge and the second spray dispenser cartridge to form a first layer;
translating the portion of the flexible conductive substrate having the first electro-active material deposited thereon through a second processing region of the spray deposition chamber between a third spray dispenser cartridge and a fourth spray dispenser cartridge; and
spraying a second electro-active material over the first electro-active material on opposing sides of the flexible conductive substrate using the third spray dispenser cartridge and the fourth spray dispenser cartridge, wherein the first processing chamber and the second processing chamber are isolated from each other to prevent cross-contamination.

19. The method of claim 18, wherein the first electro-active material comprises cathodically active particles having a first diameter and the second electro-active material comprises anodically active particles having a second diameter, wherein the second diameter is greater than the first diameter.

20. The method of claim 18, wherein the flexible conductive substrate is a web-based substrate which is translated by a feed-roll and a transfer roll.
